(19) United States
(12) Patent Application Publication
(10) Pub. No.: US 2023/0023176 A1
(43) Pub. Date: Jan. 26, 2023

(54) TURBO COMPRESSOR

(71) Applicant: LG ELECTRONICS INC., Seoul (KR)

(72) Inventors: Jun Chul OH, Seoul (KR); Kyungmin KIM, Seoul (KR); Seheon CHOI, Seoul (KR)

(21) Appl. No.: 17/960,241

(22) Filed: Oct. 5, 2022

Related U.S. Application Data
(62) Division of application No. 17/055,289, filed on Nov. 13, 2020, now Pat. No. 11,480,194.

(30) Foreign Application Priority Data
May 15, 2018 (KR) 10-2018-0055675
May 15, 2018 (KR) 10-2018-0055676

(51) Int. Cl. F04D 29/58; F04D 17/10; F04D 29/051; F04D 29/053; F04D 29/054

(52) U.S. Cl. CPC F04D 29/582; F04D 17/10; F04D 29/0513; F04D 29/053; F04D 29/054

(57) ABSTRACT

A turbo compressor may include a motor casing having a motor space; a drive motor provided in the motor space; a rotary shaft coupled to the drive motor and configured to transmit a rotational force; an impeller coupled to a first side of the rotary shaft and configured to rotate together with a rotation of the rotary shaft; a thrust bearing runner coupled to a second side of the rotary shaft opposite to the first side and configured to rotate together with the rotation of the rotary shaft; a bearing casing to support the thrust bearing runner; an inlet flow path configured to guide fluid introduced into the impeller; a discharge flow path configured to guide fluid discharged from the impeller; and a cooling flow path branched from the discharge flow path and configured to guide the fluid to the bearing casing.

### CROSS-REFERENCE TO RELATED APPLICATIONS

This application is a Divisional Application of prior U.S. patent application Ser. No. 17/055,289 filed Nov. 13, 2020, which claims priority to U.S. National Stage Application under 35 U.S.C. § 371 of PCT Application No. PCT/KR2019/004955, filed Apr. 24, 2019, which claims priority to Korean Patent Application Nos. 10-2018-0055675 and 10-2018-0055676, both filed May 15, 2018, whose entire disclosures are hereby incorporated by reference.

### BACKGROUND

### Field

A turbo compressor is disclosed herein.

### 2. BACKGROUND

Compressors include reciprocating compressors, screw compressors, and turbo compressors. A reciprocating compressor compresses gas by a reciprocating motion of a piston in a cylinder, and a screw compressor compresses gas based on rotation of a screw rotor including two shafts each having a pair of torsion threads, for example, an internal thread and an external thread.

A turbo compressor is an example of a centrifugal compressor and compresses gas based on a centrifugal force generated by rotating a wheel of a rear wing in a casing. Turbo compressors have advantages of large capacity, low noise, and easy maintenance compared to reciprocating compressors and screw compressors. In addition, the turbo compressors may produce clean compressed gas that does not contain oil.

Gas-compressing components of a centrifugal turbo compressor include an impeller to accelerate gas and a diffuser to decelerate the accelerated gas flow and convert into pressure energy. When the motor rotates the impeller at a relatively high speed, external gas is suctioned along an axial direction of the impeller, and the suctioned gas is discharged in a centrifugal direction of the impeller.

An important factor in the design of the turbo compressor is a first bending mode of the rotary shaft. A design to ensure a rigidity of the rotary shaft is important to avoid a critical speed of the rotary shaft in the first bending mode thereof.

FIG. 1 shows a cross section of a related art turbo compressor. FIG. 2 shows a rotary shaft of a related art turbo compressor.

Referring to FIGS. 1 and 2, the related art turbo compressor includes a casing 10, a stator 12 provided in the casing 10, and a rotary shaft 20 including a rotor 22 that rotates inside of the stator 12 and having both ends coupled to an impeller.

The rotary shaft 20 includes a thrust bearing runner 25 to support a load in an axial direction. An outer diameter of the rotary shaft 20 may be designed to be equal to or less than a predetermined diameter in consideration of an index of critical speed of a thrust bearing, and all components have to be firmly coupled with a greater force to operate in a high-temperature environment.

In a high-temperature environment, the rotary shaft 20 expands due to heat. If the coupling between the impeller and the rotary shaft 20 becomes loose due to expansion, the impeller may not rotate with the rotary shaft 20 and slip may occur, thereby greatly degrading durability and reliability of the turbo compressor.

In order to resolve the above problem, U.S. Patent Publication No. 2004-0005228 (published on Jan. 8, 2004) discloses a structure using a tie bolt for a coupling force. FIG. 3 is a cross-sectional view showing a related art turbo compressor. FIG. 4 shows a cooling ring of a related art turbo compressor.

As shown, a tie rod 48 passes through a center of the rotary shaft to couple components of the rotary shaft. Both ends of a permanent magnet 52 of a rotor 42 are pressed by end caps 56 and 58, an outer circumferential surface of the permanent magnet 52 is inserted into a pressing sleeve 54, a first journal bearing shaft 40 is provided at the end cap 56, a second journal bearing shaft 44 is provided at the end cap 58, an impeller 20 is provided at the first journal bearing shaft 40, a thrust bearing 46 is provided at the second journal bearing shaft 44, and the tie rod 48 passes through and couples the above components.

This structure has an advantage of strengthening a coupling force of the axial coupling components when a tensile force is applied to the tie rod 48, but has a disadvantage in that, as the turbo compressor includes many components, and the components are coupled by the tie rod 48 passing through centers thereof, the components thereof may be coupled with eccentricity with respect to the center of the rotary shaft. The components each include through-holes. The tie rod 48 is coupled to the through-holes, passes through and is coupled to the components thereof.

In addition, a gap may exist between an outer diameter of the tie rod 48 and an inner diameter of the through-hole to couple the tie rod 48. In this case, due to the gap, the components coupled to the tie rod 48 may not be accurately aligned with respect to the center of the rotary shaft and may be coupled in an eccentric state. When eccentricity occurs, rotational moment of inertia increases, thereby degrading efficiency of the compressor.

The related art turbo compressor includes a housing 12 having a symmetric shape with respect to a central axis 14, an inlet 16 to introduce fluid to be compressed, a compressor including an impeller 20 and a diffuser 22, a motor provided in the housing 12 and including a rotor 42 and a stator 50, and a cooling ring 36 provided in the housing 12 and to surround the stator 50. The cooling ring 36 defines a spiral groove 38 (FIG. 4) on an outer circumferential surface thereof, an inlet 32, and a discharge outlet 34 to supply and recover cooling fluid between the housing 12 and the cooling ring 36.

The turbo compressor rotates at a high speed to generate heat. If the heat generated during operation of the turbo compressor is not properly cooled, friction-generating portions and the drive motor may be damaged. In addition, the related art turbo compressor includes the cooling ring 36 provided inside of the housing 12 and supplies the cooling fluid between the cooling ring 36 and the housing 12, that is, through a groove 38 defined on an outer circumferential surface of the cooling ring.

This structure cools the housing 12 and the cooling ring 36 of the turbo compressor to effectively cool the motor and indirectly cool a bearing friction portion. Therefore, when a rotational speed of the turbo compressor is increased, the bearing has to be cooled. However, the structure in the related art has a problem in that the structure does not effectively cool the bearing.

### BRIEF DESCRIPTION OF THE DRAWINGS

FIG. 1 shows a cross section of a related art turbo compressor;

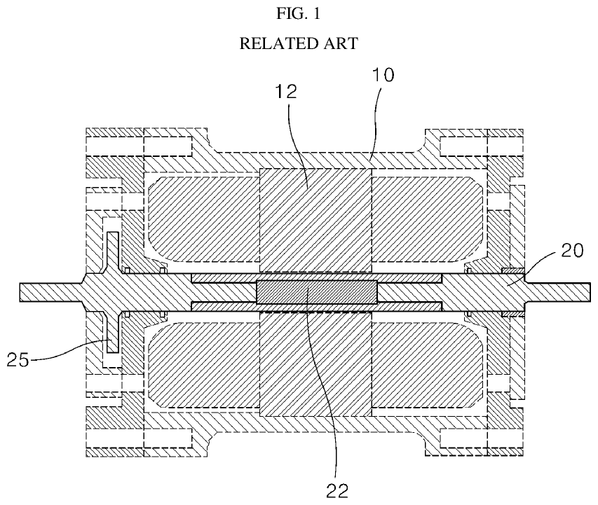

FIG. 2 shows a rotary shaft of a related art turbo compressor;

FIG. 3 shows a cross section of a related art turbo compressor;

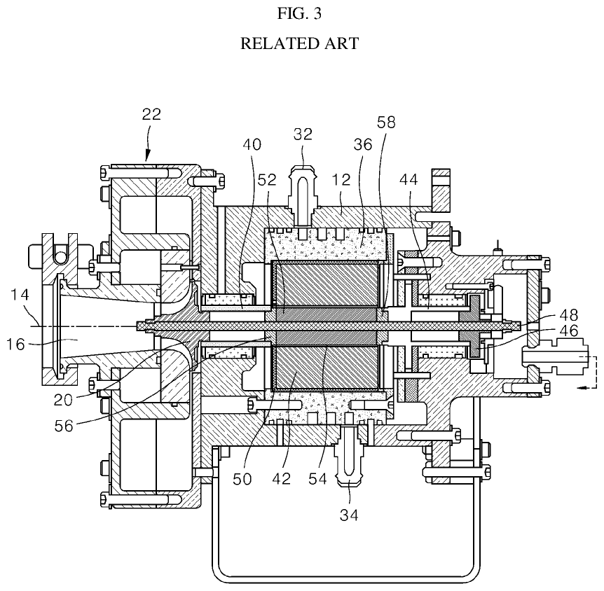

FIG. 4 shows a cooling ring of a related art turbo compressor;

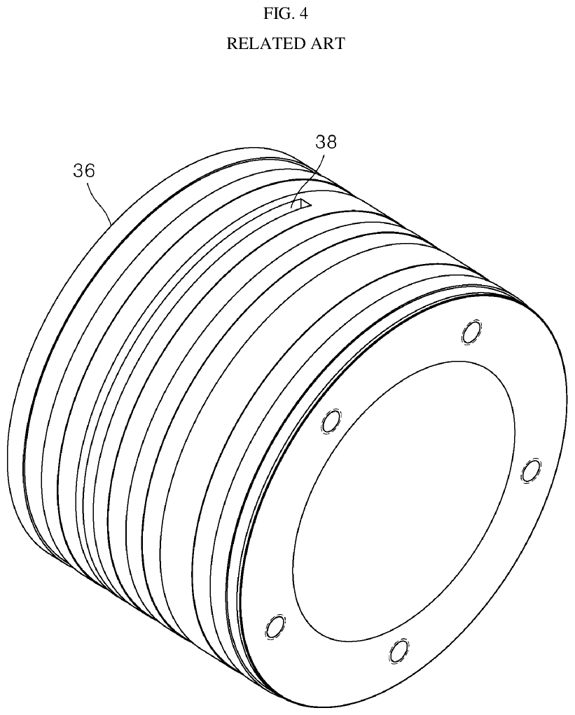

FIG. 5 shows a rotary shaft of a turbo compressor according to an embodiment;

FIG. 6 is an enlarged view showing a coupling portion between a rotary shaft of a turbo compressor and a thrust bearing runner according to an embodiment;

FIG. 7 is an enlarged view showing a coupling portion of a rotary shaft of a turbo compressor and a second impeller according to an embodiment;

FIG. 8 is a graph showing deformation of stainless steel (SUS 304) material with respect to stress;

FIG. 9 is a graph showing a relation between deformation and a coupling force of a tie bolt;

FIG. 10 is a schematic diagram of a turbo compressor according to another embodiment;

FIG. 11 is a schematic diagram of a turbo compressor according to still another embodiment;

FIG. 12 is a schematic diagram showing a turbo compressor according to yet another embodiment;

FIG. 13 is a schematic diagram of a turbo compressor according to yet another embodiment;

FIG. 14 is a schematic diagram showing a turbo compressor according to yet another embodiment; and

FIG. 15 is a diagram showing a turbo compressor according to yet another embodiment.

### DETAILED DESCRIPTION

Hereinafter, embodiments will be described in detail with reference to the accompanying drawings. Reference now should be made to the drawings, in which the same reference numerals are used throughout the different drawings to designate the same or similar components. A detailed description of a well-known configuration or function may be omitted if it unnecessarily obscures the gist of the present disclosure.

In some examples, terms such as first, second, A, B, (a), and (b), for example, may be used herein when describing elements. These terms are intended to distinguish one element from other elements, and the essence, order, or sequence of corresponding elements are not limited by these terms. It should be noted that if it is described in the present disclosure that one component is “connected,” “coupled” or “joined” to another component, the former may be directly “connected,” “coupled” or “joined” to the latter or “connected,” “coupled” or “joined” to the latter via another component.

A turbo compressor is an example of a centrifugal compressor and compresses gas based on a centrifugal force generated by rotating an impeller in a casing. The turbo compressor suctions gas in an axial direction using a rotational force of the impeller and then discharges the gas in a centrifugal direction to perform a compression operation. A two-stage compression turbo compressor has been used as an example of the turbo compressor.

A number of stages of the turbo compressor may be determined based on a number of impellers. The turbo compressor may be classified into a back-to-back type turbo compressor or a face-to-face type turbo compressor according to an arrangement of impellers.

In the back-to-back type turbo compressor, rear or base surfaces of the impellers face each other. In the face-to-face type turbo compressor, suction ends of the impellers face each other.

The turbo compressor according to an embodiment described hereinafter is a two-stage, back-to-back type turbo compressor including two impellers having rear surfaces facing each other.

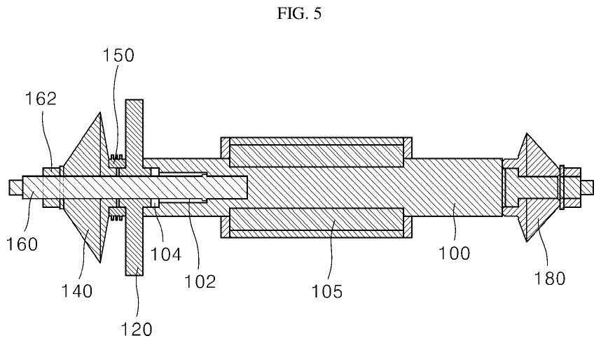

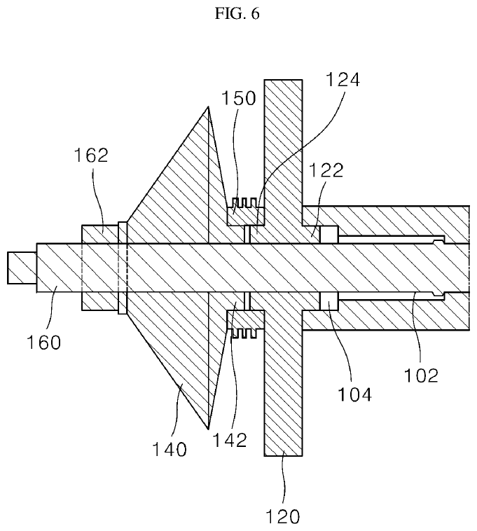

FIG. 5 shows a rotary shaft of a turbo compressor according to an embodiment. FIG. 6 is an enlarged view showing a coupling portion between a rotary shaft of a turbo compressor and a thrust bearing runner according to an embodiment.

An important factor for miniaturizing the turbo compressor is a first bending mode of the rotary shaft. The rotary shaft rotates at a high speed and is operated under high-pressure conditions, and if the rotary shaft is in the first bending mode within a range of operating speed, reliability of operation may not be obtained.

In order for the rotary shaft to be suitable for high-speed operation, the rotary shaft may have a relatively short length and a relatively larger diameter to facilitate rigidity. However, there is a limitation in that there is difficulty in increasing a diameter of the shaft because a Diameter Nominal (DN) number, which is a design limit of the bearing, has to be considered with respect to the diameter of the shaft.

Embodiments disclosed herein provide a structure of the turbo compressor to obtain a force that couples two impellers and the thrust bearing runner to the rotary shaft.

Referring to FIGS. 5 and 6, the turbo compressor according to an embodiment includes a rotary shaft 100 having a rotor 105, a thrust bearing runner 120 provided at one or a first side of the rotary shaft 100, a first impeller 140 provided outside of the thrust bearing runner 120, a tie rod 160 to couple the first impeller 140 and the thrust bearing runner 120 to the rotary shaft 100 by applying a preload to the tie rod 160, and a second impeller 180 coupled to the other or a second side of the rotary shaft 100. The second impeller 180 may have an outer diameter that is relatively smaller than that of the first impeller 140. In other words, the thrust bearing runner 120 may be close to the impeller having the relatively large diameter, that is, the first impeller 140.

As the diameter of the first impeller 140 increases, axial load applied to a rear surface of the first impeller 140 increases. The thrust bearing runner 120 is provided at a rear or base surface of the first impeller 140 having the relatively large diameter to effectively support rotation of the first impeller 140.

The rear surface of the first impeller 140 may mean a right surface in FIG. 5, or a surface at an end of the first impeller 140 having a base plate or a surface at an end of the first impeller 140 having a diameter greater than a remaining portion of the first impeller 140. As embodiments disclosed herein provide a back-to-back turbo compressor in which rear surfaces of impellers face each other, the rear surface of the second impeller 180 may mean a left surface in FIG. 5, or a surface facing the rear surface of the first impeller 140. If a frontward-rearward direction of the turbo compressor is defined as a direction from the first impeller 140 to the second impeller 180, the “rear surface” of the second impeller 180 may be in front of a surface of the second impeller 180 opposite to the rear surface.

In addition, the rotor 105 may protrude from other portions of the rotary shaft 110. The rotor 105 includes a permanent magnet and easily performs a high-speed rotation as a size of the permanent magnet is increased. Therefore, an outer diameter of the rotor 105 is increased to obtain a rotational force of a drive motor.

As described above, when the diameter of the rotary shaft 100 is increased, the rotary shaft 100 has a disadvantage in terms of DN number, which is a limitation of a journal bearing supporting the rotary shaft 100. The DN number is calculated as a product of a diameter of the rotary shaft 100 and a number of rotations thereof. As the diameter of the rotary shaft 100 is increased, the DN number is increased. Accordingly, according to embodiments disclosed herein, both side portions of the rotary shaft 100 have diameters that are each smaller than the diameter of the rotor 105, thereby improving stability in high-speed rotation.

According to embodiments disclosed herein, the turbo compressor couples the thrust bearing runner 120 and the first impeller 140 using the tie rod 160 in a state in which preload is applied, thereby obtaining the coupling force between the thrust bearing runner 120 and the first impeller 140. When the turbo compressor rotates, the first impeller 140 receives a load in a leftward (lateral) or forward direction in FIG. 5 based on a pressure difference generated by the rotation. To compensate for the load, the preload is applied to the tie rod 160 to couple the first impeller 140 and the thrust bearing runner 120 to the rotary shaft 100.

The rotary shaft 100 includes a hollow groove 102 by which the tie rod 160 is coupled to the rotary shaft 100 by applying the preload to the tie rod 160. The hollow groove 102 has an inner diameter that is larger than an outer diameter of the tie rod 160.

The tie rod 160 has one or a first end coupled through the hollow groove 102 and the other or a second end coupled to a fastening nut 162. In other words, when the fastening nut 162 is tightened while the thrust bearing runner 120 and the impeller 140 are inserted between a left or first end of the rotary shaft 100 and the fastening nut 162, the tie rod 160 is tensioned, and the impeller 140 and the thrust bearing runner 120 are compressed and coupled.

A magnitude of the preload applied to the tie rod 160 may be set by adjusting a degree of tightening of the fastening nut 162. The hollow groove 102 is defined to allow the tie rod 160 to be in the tensioned state when the tie rod 160 is coupled and has an inner diameter that is larger than an outer diameter of the tie rod 160.

When a frictional force occurs between the tie rod 160 and the hollow groove 102, a portion of the preload applied to the tie rod 160 is canceled or countered by the frictional force between the tie rod 160 and an inner wall of the hollow groove 102. In this case, the preload applied to the tie rod 160 may not act as a fastening force.

An impeller sleeve 150 may be provided between the first impeller 140 and the thrust bearing runner 120 to achieve sealing performance of the first impeller 140. The impeller sleeve 150 may have a concavo-convex shape to prevent fluid leakage between the first impeller 140 and the impeller housing. For example, the impeller sleeve 150 may be made of a labyrinth seal.

According to embodiments disclosed herein, the impeller sleeve 150 is provided between the first impeller 140 and the thrust bearing runner 120 to provide a coupling force for coupling the first impeller 140 and the thrust bearing runner 120. As shown, the ends of the thrust bearing runner 120 and the first impeller 140 are inserted into the inner diameter of the impeller sleeve 150, and the impeller sleeve 150 surrounds an outer circumference of a connecting portion between the first impeller 140 and the thrust bearing runner 120 and couples the first impeller 140 and the thrust bearing runner 120.

For this coupling, a coupling shaft portion or shaft 142 is provided at a rear or right side of the first impeller 140, and a coupling shaft portion or shaft 124 is provided at a front or left side of the thrust bearing runner 120. The coupling shaft portion 142 and the coupling shaft portion 124 are inserted into the impeller sleeve 150.

In this case, an outer diameter of each of the coupling shafts 142, 124 is larger than the inner diameter of the impeller sleeve 150. When the coupling shaft portions 142, 124 are forcibly coupled to or fitted into the impeller sleeve 150, the impeller sleeve 150 may provide the coupling force to couple the first impeller 140 and the thrust bearing runner 120.

In this case, a sum of lengths of the coupling shaft portions 142 and 124 is smaller than a length of the impeller sleeve 150 such that there may be a gap or such that the coupling shaft portions 142 and 125 do not contact each other, and the pre load is applied to the first impeller 140 and the thrust bearing runner 120 by tightening the fastening nut 162 coupled to the tie rod 160. Thus, the impeller sleeve 150 is compressed and coupled between the first impeller 140 and the thrust bearing runner 120.

When a sum of lengths of the coupling shaft portions 142 and 124 is equal to or larger than that of the impeller sleeve 150, the coupling shaft portions 142 and 124 contact each other to prevent compression of the first impeller 140 and the thrust bearing runner 120 by the impeller sleeve 150. In addition, the thrust bearing runner 120 coupled between the first impeller 140 and the rotary shaft 100 may also be coupled to the rotary shaft 100 by stationary fitting.

As shown, the rotary shaft 100 includes a coupling groove 104 at an end of the hollow groove 102, the coupling groove 104 has an inner diameter that is larger than the inner diameter of the hollow groove 102, and the thrust bearing runner 120 includes a coupling shaft 122. The coupling shaft 122 may be coupled to the coupling groove 104 by stationary fitting.

An outer diameter of the coupling shaft 122 is larger than the inner diameter of the coupling groove 104 to forcibly couple the coupling shaft 122 of the thrust bearing runner 120 to the coupling groove 104. Therefore, a contact area between the rotary shaft 100 and the thrust bearing runner 120 provided between the first impeller 140 and the rotary shaft 100 may be obtained to provide a coupling force between the thrust bearing runner 120 and the rotary shaft 100. The thrust bearing runner 120 inserted into the coupling groove 104 is shorter than a depth of the coupling groove 104 such that a compressive force is applied between the thrust bearing runner 120 and the left end of the rotary shaft 100 by the preload applied to the tie rod 160.

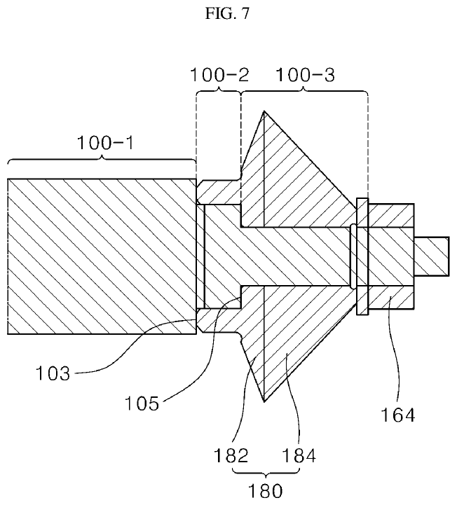

FIG. 7 is an enlarged view showing a coupling portion between a rotary shaft and a second impeller of a turbo compressor according to an embodiment. Referring to FIG. 7, the second impeller 180 has a diameter that is relatively smaller than that of the first impeller 140 and is coupled to the rotary shaft 100 with multiple stages for providing a coupling force to couple the second impeller 180 and the rotary shaft 100.

The second impeller 180 may be directly coupled to the rotary shaft 100 using a fastening bolt 164. The end of the rotary shaft 100 coupled to the second impeller 180 has a multi-stage structure in which a diameter is reduced with two stages.

Hereinafter, a portion with a largest diameter of the rotary shaft 100 is referred to as a large-diameter or first portion 100-1, a portion with a smallest diameter of the rotary shaft 100 is referred to as a small-diameter or third portion 100-3, and a portion with a diameter that is smaller than the diameter of the large diameter portion 100-1 and larger than the diameter of the small-diameter portion 100-3 is referred to as a middle-diameter or second portion 100-2. The large-diameter, middle-diameter, and small-diameter portions 100-1, 100-2, and 100-3 may alternatively be referred to as first, second, and third sections.

The second impeller 180 is coupled to the middle-diameter portion 100-2 and the small-diameter portion 100-3. The second impeller 180 includes a base plate 182 and an impeller blade 184 provided on the base plate 182.

A rotary shaft fastening hole of the second impeller 180 has a first inner diameter corresponding to the middle-diameter portion 100-2 on the base plate 182 and has a second inner diameter corresponding to the small-diameter portion 100-3 on the impeller blade 184. This structure has an effect of increasing an effective area of the impeller blade 184 by reducing the inner diameter of the impeller blade 184.

In addition, a stronger coupling force to couple the rotary shaft 100 and the second impeller 180 may be set. When the second impeller 180 is coupled to the rotary shaft 100 in multiple stages, a radial and/or circumferential surface of the rotary shaft 100 contacts the second impeller 180, and the contact area thereof is enlarged. Accordingly, the coupling force to couple the second impeller 180 and the rotary shaft 100 may be increased.

An inner surface of the second impeller 180 is supported by a first stepped surface 103 between the large-diameter portion 100-1 and the middle-diameter portion 100-2 of the rotary shaft 100, and a stepped surface inside of the base plate 182 of the second impeller 180 is supported by a second stepped surface 106 between the middle-diameter portion 100-2 and the small-diameter portion 100-3 of the rotary shaft 100. This structure allows the coupling contact on which the frictional force acts to be expanded when the second impeller 180 is coupled to the rotary shaft 100 by stationary fitting or shrink-fitting.

In addition, when the fastening bolt 164 is coupled, the second impeller 180 is compressed between the first stepped surface 103 of the rotary shaft 100 and the fastening bolt 164, and the middle diameter portion 100-2 and the small diameter portion 100-3 of the rotary shaft 100 are tensioned. The preload applied to the second impeller 180 at the middle diameter portion 100-2 and the small diameter portion 100-3 of the rotary shaft 100 may be adjusted by controlling the fastening force of the fastening bolt 164. In this structure, the first impeller 140 and the second impeller 180 receiving the greatest force are symmetrical to each other in the forward-rearward direction (or leftward-rightward direction) and are equally deformed in the forward-rearward direction. If deformation is biased to one side, reliability of the turbo compressor may be deteriorated due to the deformation during high-speed operation.

The tie rod 160 may be coupled to the rotary shaft 100 in a state in which the tension load is applied to the tie rod 160 based on a tightening force of the fastening nut 162.

In other words, the tie rod 160 may be coupled in the state in which the preload is applied to the tie rod 160. Therefore, even if deformation occurs in the tie rod 160 due to thermal expansion and a tensile force is reduced, the preload applied to the tie rod 160 absorbs the deformation due to the thermal expansion, thereby enabling reliable coupling of the tie rod 160.

In order to reduce a size of the turbo compressor and perform high-speed rotation, the first impeller 140 and the thrust bearing runner 120 are coupled using the tie rod 160 in the state in which the preload is applied and the second impeller 180 is coupled to the rotary shaft 100 by applying the preload to the small diameter portion of the multistage rotary shaft 100. Therefore, embodiments disclosed herein have an effect of obtaining the coupling force between the rotating components of the turbo compressor rotating at the high speed.

A result of an experiment of rotating the rotary shaft having a length of 177 mm and an outer diameter of 125 mm at 200,000 rpm is as follows.

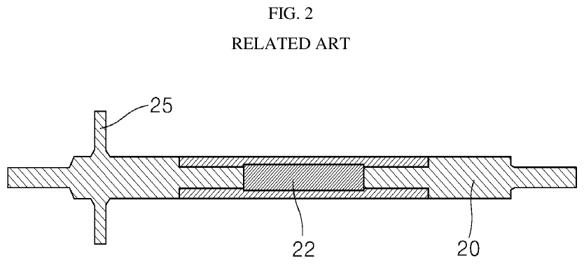

First bending frequency was 2,250.5 Hz and the DN Number was 2,500,000 mmxrpm. It was found that the first bending frequency was within a range of the operating speed, and thus, the turbo compressor shown in FIG. 2 was not suitable for high-speed operation.

A result of an experiment in which the rotary shaft shown in FIG. 5 having a length of 135.5 mm and an outer diameter of 14.5 mm of the turbo compressor of FIG. 5 according to this embodiment is rotated at 200,000 rpm is as follows.

First bending frequency was 5,1362.2 Hz and a DN Number was 2,900,000 mmxrpm. It was found that the first bending frequency was outside of an operating speed range, and thus, the rotary shaft 100 is suitable for high-speed operation.

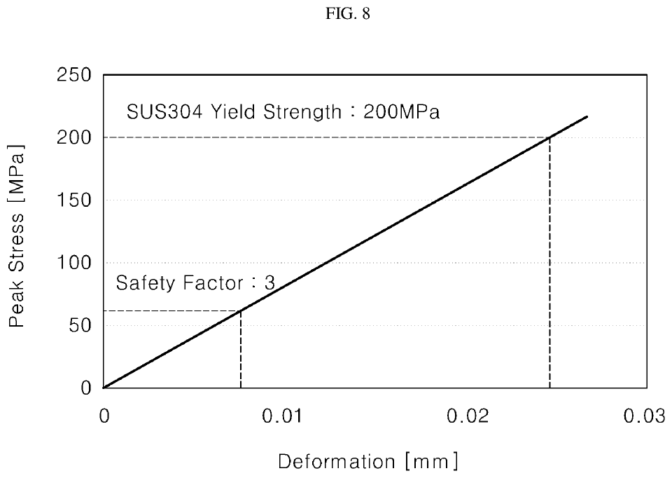

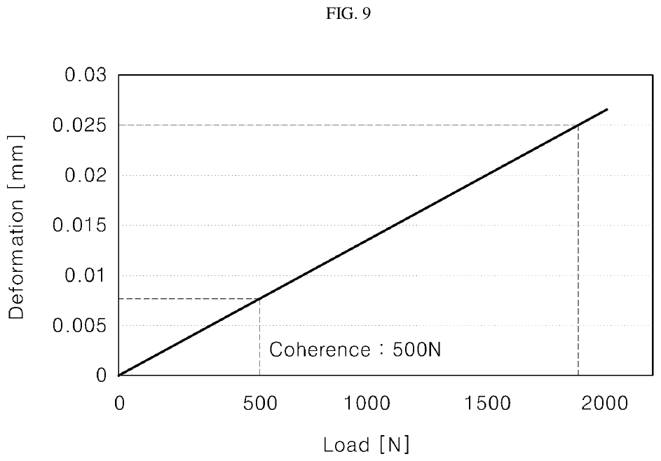

FIG. 8 is a graph showing deformation with respect to stress of a stainless steel (SUS 304) material. FIG. 9 is a graph showing a relation between deformation and a coupling force of a tie rod.

Referring to FIGS. 8 and 9, the tie rod, for example, tie rod 160 of FIG. 5, is made of, for example, a stainless steel (SUS 304) material. According to the graph showing the deformation of the SUS 304 material with respect to the stress, it can found that, if a safety factor is 3, the deformation may be less than 25 μm. In addition, if the deformation of the tie rod is set in a range from 7 to 25 μm, preload of the rotary shaft 100 may be set to 500 to 1800 N.

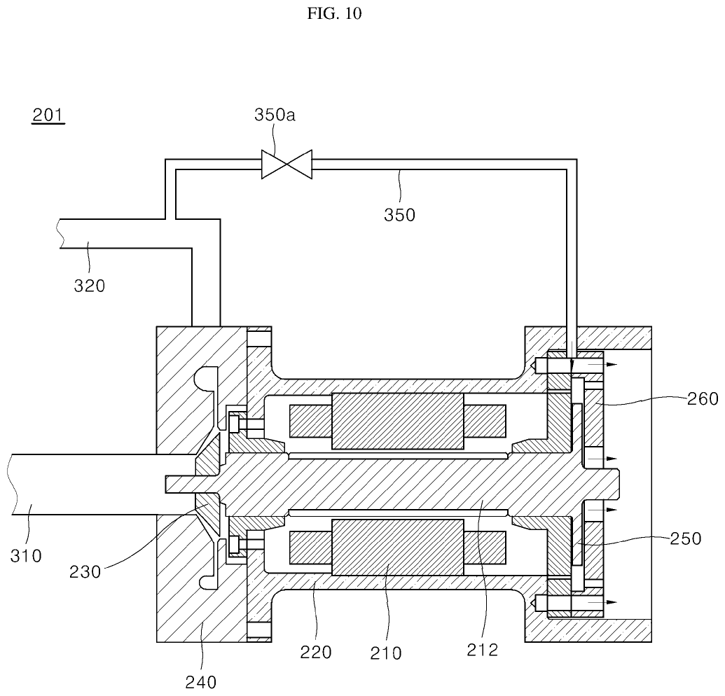

FIG. 10 is a schematic diagram of a turbo compressor according to another embodiment. Referring to FIG. 10, turbo compressor 201 according to this embodiment includes a drive motor 210 including a rotary shaft 212, an impeller 230 coupled to the rotary shaft 212, a thrust bearing runner 250 to support load in an axial direction of the rotary shaft 212, and casings 220, 240, and 260 to accommodate or receive the drive motor 210, the impeller 230, and the thrust bearing runner 250.

The casings 220, 240, 260 may include a motor casing 220 to accommodate or receive the drive motor 210, an impeller casing 240 to accommodate or receive the impeller 230, and a bearing casing 260 to accommodate or receive the thrust bearing runner 250. A stator of the drive motor 210 is provided inside of the motor casing 220.

The impeller casing 240 constitutes a compressor together with the impeller 230. An inlet flow path 310 to guide inflow of fluid and a discharge flow path 320 to guide the fluid discharged after being compressed by the compressor are each connected to the compressor.

In addition, the turbo compressor 201 may include a cooling flow path 350 branched from the discharge flow path 320 and connected to the bearing casing 260. A portion of the fluid discharged through the discharge flow path 320 of the turbo compressor 201 is supplied to an inside of the bearing casing 260 to accommodating the thrust bearing runner 250 to cool heat generated at the thrust bearing runner 250.

The turbo compressor 201 includes drive motor 210, motor casing 220, impeller 230 coupled to the rotary shaft 212, impeller casing 240, thrust bearing runner 250 coupled to the rotary shaft 212, bearing casing 260 to accommodate the thrust bearing runner 250, inflow flow path 310 to guide fluid to an inlet of the impeller casing 240, discharge flow path 320 to guide the fluid discharged from a discharge outlet of the impeller casing 240, and a cooling flow path 350 to connect the discharge glow path 320 and the bearing casing 260 to supply the fluid to the inside of the bearing casing 260. This structure may cool the turbo compressor 201 using the fluid without using additional refrigerant or a separate coolant or cooling fluid to cool the turbo compressor 201, thereby removing or not requiring the cooling ring of the related art or the inlet and the discharge outlet of the refrigerant connected to the cooling ring. The cooling ring which surrounds an outer circumferential surface of the drive motor may be removed to reduce a size of the turbo compressor.

In addition, the portion of the fluid discharged through the discharge flow path 320 is supplied to the inside of the bearing casing 260 to cool the thrust bearing runner 250. In this case, a flow rate control means or controller may be provided at the cooling flow path 350 to adjust a flow rate of the fluid supplied into the bearing casing 260 through the cooling flow path 350.

The flow rate control of the fluid supplied through the cooling flow path 350 may be performed by adjusting a cross-sectional area of the cooling flow path 350. In other words, the flow rate of the fluid flowing through the cooling flow path 350 may be adjusted by providing an orifice or a capillary tube in a portion of the cooling flow path 350.

The turbo compressor 201 supplies the portion of the fluid discharged through the discharge flow path 320 into the bearing casing 260. If an excessive amount of the flow rate of the fluid is supplied through the cooling flow path 350 of the turbo compressor 201, performance of the compressor is deteriorated. For this reason, the flow rate of the fluid supplied to the bearing casing 260 through the cooling flow path 350 may be appropriately adjusted.

In addition, the turbo compressor may include a check valve 350a provided in the cooling flow path 350 to prevent backflow of fluid.

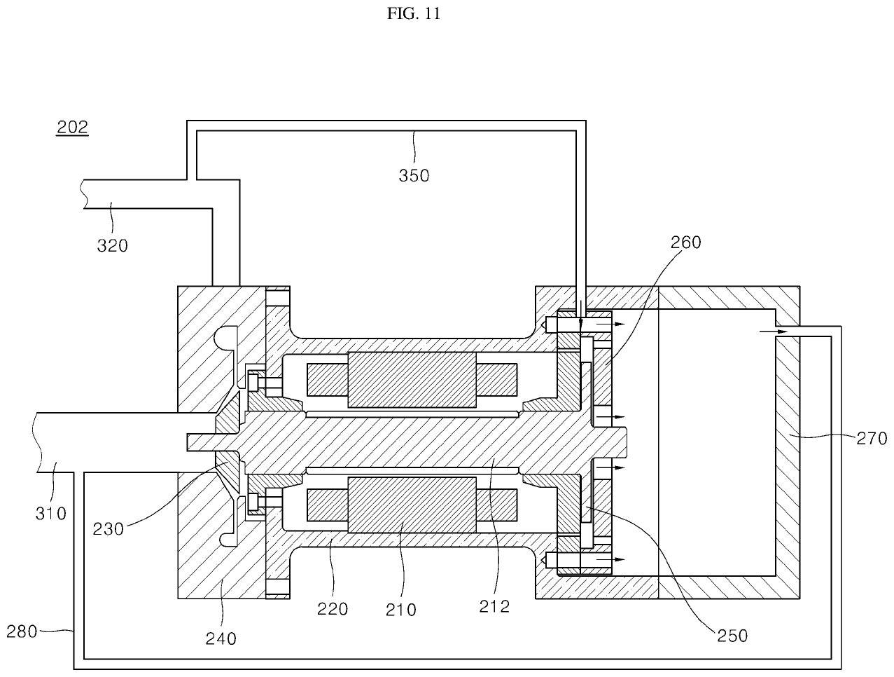

FIG. 11 is a schematic diagram of a turbo compressor according to still another embodiment. Referring to FIG. 11, turbo compressor 202 according to this embodiment includes drive motor 210, motor casing 220, impeller 230, impeller casing 240, thrust bearing runner 250, bearing casing 260, inlet flow path 310, discharge flow path 320, and cooling flow path 350 similar to the previous embodiment.

In addition, the turbo compressor 202 according to this embodiment further includes a recovery chamber 270 to receive fluid supplied to an inside of the bearing casing 260 through the cooling flow path 350 and a recovery flow path 280 to return the fluid received in the recovery chamber 270 to the compressor.

The recovery chamber 270 provides a space to temporarily store the fluid which is supplied to the inside of the bearing casing 260 through the cooling flow path 350 and stably supply the fluid to the bearing casing 260. The fluid flows based on a pressure difference. A velocity and the flow rate of the fluid passing through the bearing casing 260 may be set or predetermined based on a pressure difference between the cooling flow path 350 and the recovery chamber 270.

The turbo compressor 202 recovers the fluid used to cool the thrust bearing runner 250 through the recovery chamber 270 and supplies the fluid to the inflow path 310 through the recovery flow path 280, thereby preventing fluid leakage. The fluid supplied through the discharge flow path 320 has high pressure, but the fluid pressure is decreased as the fluid passes through the inside of the bearing casing 260 and the recovery chamber 270. In this case, the fluid with the reduced pressure is recovered to the inlet flow path 310 through the recovery flow path 280, and the recovered fluid may be recompressed by the impeller 230.

The turbo compressor 202 according to this embodiment may further include a flow rate control valve at the recovery flow path 280. The flow velocity and the flow rate of the fluid supplied to the inside of the bearing casing 260 may be adjusted using the flow rate control valve provided in the recovery flow path 280.

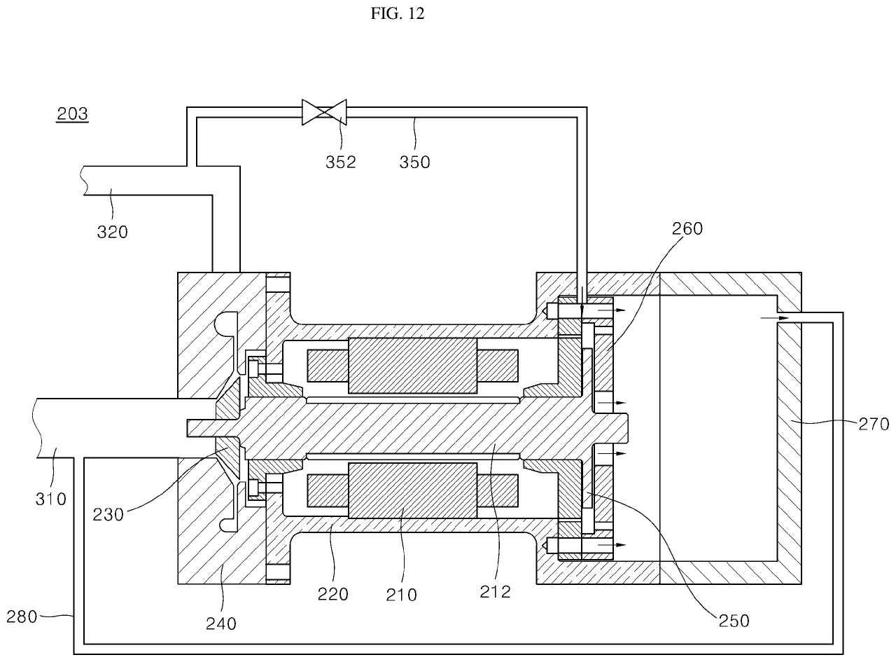

FIG. 12 is a schematic diagram of a turbo compressor according to still another embodiment.

Referring to FIG. 12, turbo compressor 203 according to this embodiment includes drive motor 210 including rotary shaft 212, motor casing 220 to accommodate the drive motor 210, impeller 230 coupled to one side of the rotary shaft 212, impeller casing 240 to accommodate the impeller 230, thrust bearing runner 250 coupled to the other side of the rotary shaft 212, bearing casing 260 to accommodate the thrust bearing runner 250, inflow flow path 310 to guide fluid to an inlet of the impeller casing 240, discharge flow path 320 to guide fluid discharged through a discharge outlet of the impeller casing 240, cooling flow path 350 to connect the discharge flow path 320 and the bearing casing 260 to supply the fluid to an inside of the bearing casing 260, recovery chamber 270 to receive the fluid supplied to the bearing casing 260, recovery flow path 280 to guide the fluid received in the recovery chamber 270 to the inlet flow path 310, and a flow rate control valve 352 included in the cooling flow path 350 to adjust a flow rate of the fluid flowing through the cooling flow path 350 and to adjust the flow rate of fluid supplied to a bearing. For example, in the case of low-speed operation in which cooling of the thrust bearing runner 250 is not needed, the flow rate control valve 352 is closed to prevent degradation in compression efficiency, and in the case of high-speed operation, the flow rate control valve 352 is opened to supply the fluid into the bearing casing 260 through the cooling flow path 350.

An opening rate or degree of the flow rate control valve 352 may be adjusted based on a temperature inside of the bearing casing 260 or a rotational speed of the drive motor 210.

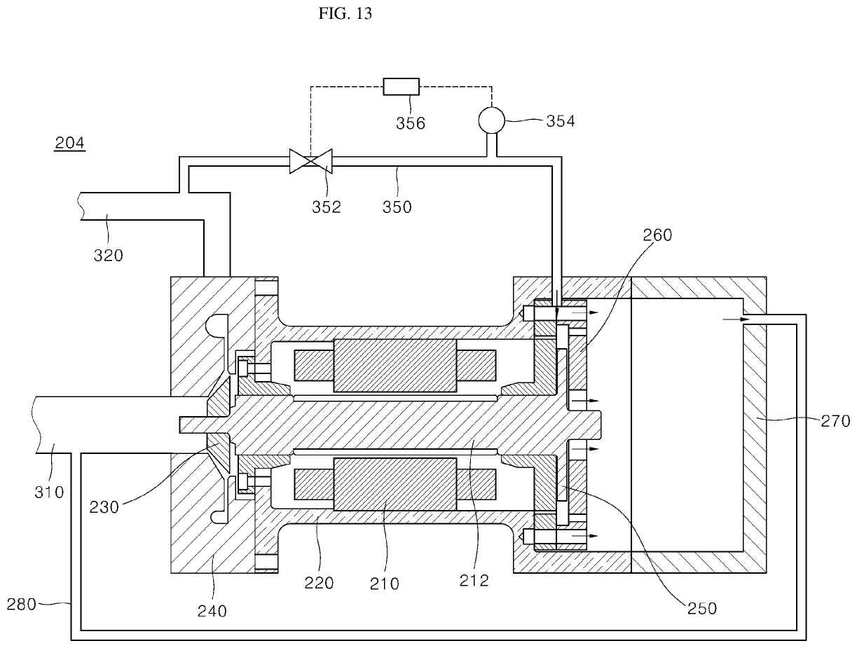

FIG. 13 is a configuration diagram showing a turbo compressor according to still another embodiment. Referring to FIG. 13, turbo compressor 204 according to this embodiment includes drive motor 210 including rotary shaft 212, motor casing 220 to accommodate the drive motor 210, impeller 230 coupled to one side of the rotary shaft 212, impeller casing 240 to accommodate the impeller 230, thrust bearing runner 250 coupled to the other side of the rotary shaft 212, bearing casing 260 to accommodate the thrust bearing runner 250, inlet flow path 310 to guide fluid to an inlet of the impeller casing 240, discharge flow path 320 to guide the fluid discharged from an outlet of the impeller casing 240, cooling flow path 350 to connect the discharge flow path 320 and the bearing casing 260 to supply fluid into the bearing casing 260, recovery chamber 270 to receive the fluid supplied to the bearing casing 260, recovery flow path 280 to guide the fluid received in the recovery chamber 270 to the inlet flow path 310, flow rate control valve 352 provided in the cooling flow path 350 to control a flow rate of the fluid flowing through the cooling flow path 350, pressure sensor 354 provided downstream of the flow rate control valve 352 and to sense a pressure of fluid passing through the flow rate control valve 352, and a controller 356 to receive information on the pressure detected by the pressure sensor 354 and adjust an opening rate or degree of the flow control valve 352. The turbo compressor 204 includes the pressure sensor 354 on the downstream side of the flow rate control valve 352 to measure an actual pressure of the fluid supplied through the cooling flow path 350 and accurately control the flow rate of the fluid supplied to the bearing casing 260.

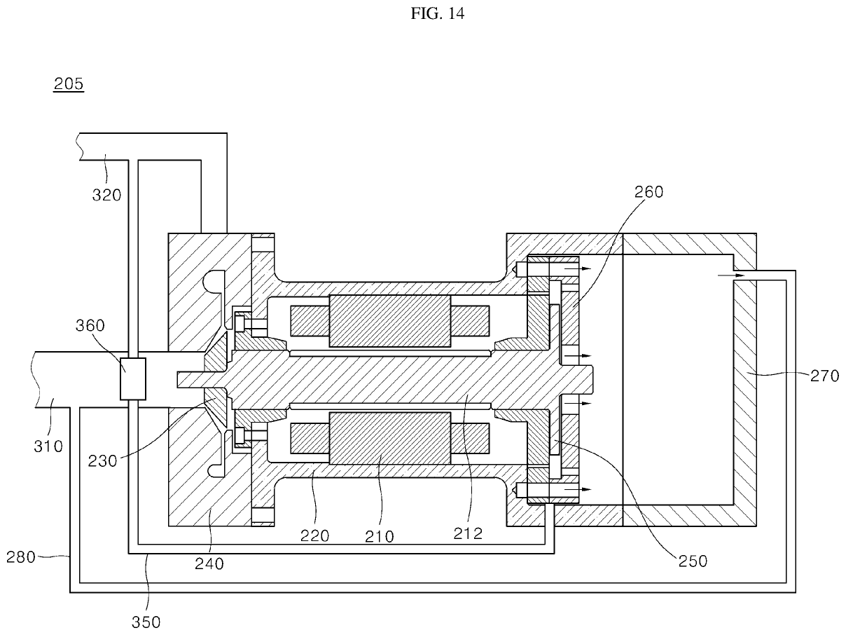

FIG. 14 is a schematic diagram of a turbo compressor according to still another embodiment. Referring to FIG. 14, turbo compressor 205 according to this embodiment includes drive motor 210 including rotary shaft 212, motor casing 220 to accommodate the drive motor 210, impeller 230 coupled to one side of the rotary shaft 212, impeller casing 240 to accommodate the impeller 230, thrust bearing runner 250 coupled to the other side of the rotary shaft 212, bearing casing 260 to accommodate the thrust bearing runner 250, inlet flow path 310 to guide fluid to an inlet of the impeller casing 240, discharge flow path 320 to guide fluid discharged from a discharge outlet of the impeller casing 240, cooling flow path 350 to connect the discharge flow path 320 and the bearing casing 260 to supply fluid into the bearing casing 260, recovery chamber 270 to receive the fluid supplied to the bearing casing 260, recovery flow path 280 to guide the fluid received in the recovery chamber 270 to the inlet flow path 310, and a heat exchanger 360 provided along or in the cooling flow path 350 and in the inlet flow path 310. Relatively high temperature fluid supplied through the cooling flow path 350 may be heat-exchanged with relatively low temperature fluid introduced through the inlet flow path 310 through the heat exchanger 360, thereby reducing a temperature of the fluid supplied through the cooling flow path 350.

The heat exchanger 360 is provided so as not to interfere with a flow of suctioned fluid. For example, in the case of a pin-tube type heat exchanger, a pin is arranged in parallel with a flow direction of the suctioned fluid.

The fluid supplied through the cooling flow path 350 cools the inside of the bearing casing 260, and the cooling effect is increased as the fluid temperature decreases. If the cooling effect is improved, the desired cooling effect of the bearing may be obtained with a relatively less flow rate of fluid. The structure has an effect of eliminating a phenomenon in which cooling is not sufficiently performed when the fluid circulating through a fluid circuit has a relatively high temperature.

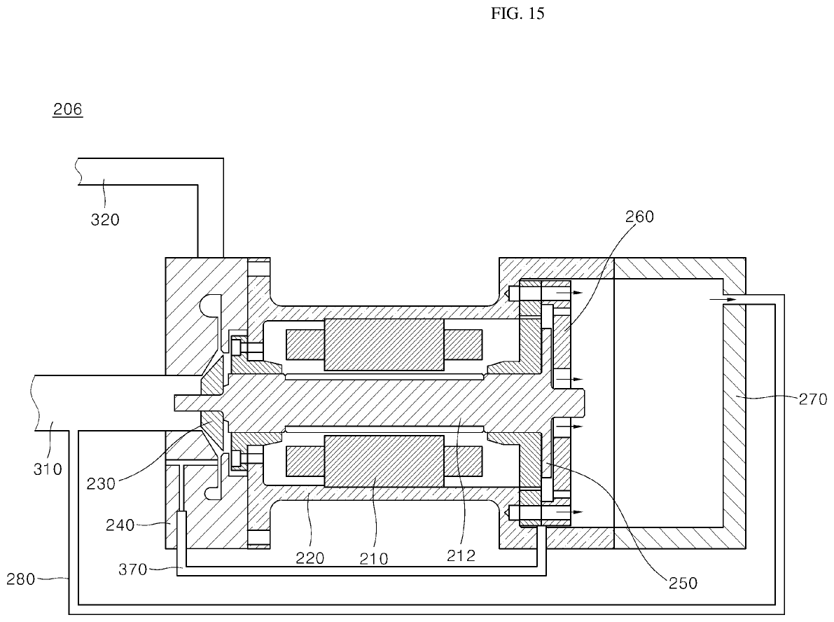

FIG. 15 is a schematic diagram of a turbo compressor according to still another embodiment. Referring to FIG. 15, turbo compressor 206 according to this embodiment includes drive motor 210 including rotary shaft 212, motor casing 220 to accommodate the drive motor 210, impeller 230 coupled to one side of the rotary shaft 212 and rotating together with the rotary shaft 212, impeller casing 240 to accommodate the impeller 230 and including a diffuser to convert flow of gas accelerated by the impeller 230 into pressure energy, thrust bearing runner 250 coupled to the other side of the rotary shaft 212 and rotating together with the rotary shaft 212, bearing casing 260 to support the thrust bearing runner 250, inlet flow path 310 to guide fluid introduced into the impeller casing 240, discharge flow path 320 to guide fluid discharged from the impeller casing 240, cooling flow path 350 connected to the diffuser of the impeller casing 240 and to guide the fluid in the diffuser to the bearing casing 260, recovery chamber 270 to receive the fluid discharged from the bearing casing 260, and recovery flow path 280 to guide the fluid received in the recovery chamber 270 to the inlet flow. The cooling flow path 350 of the turbo compressor 206 is connected to the impeller casing 240 and may not be connected to the discharge flow path 320.

The fluid inside of the impeller casing 240 has pressure that is relatively lower than that of the fluid inside of the discharge flow path 320, thereby reducing compression loss of the fluid supplied to the cooling flow path 350. In addition, the configurations of the flow rate control valve 352, the pressure sensor 354, and the controller 356 of the above-described embodiments, that is, in FIG. 13, may be used.

Embodiments disclosed herein solve the problems associated with the related art and provide a turbo compressor capable of avoiding a first bending mode of a rotary shaft even during high-speed rotation by obtaining rigidity of the rotary shaft of the turbo compressor. Embodiments disclosed herein also provide a turbo compressor in which components coupled to the rotary shaft may be accurately aligned with respect to a center of the rotary shaft.

Embodiments disclosed herein provide a turbo compressor capable of maintaining a rigidly fixed state of components such as an impeller even in a high-temperature environment in which the turbo compressor is operated at a high speed. Embodiments disclosed herein further provide a turbo compressor suitable for miniaturization.

Embodiments disclosed herein provide a turbo compressor including a cooling flow path to supply fluid to a thrust bearing runner to stably operate at a high speed. Embodiments disclosed herein additionally provide a turbo compressor capable of supplying a portion of refrigerant discharged through a discharge flow path to an inside of a bearing casing to cool a thrust bearing. Embodiments disclosed herein further provide a turbo compressor capable of supplying a portion of refrigerant inside an impeller casing to the inside of the bearing casing and to cool the thrust bearing.

Embodiments disclosed herein provide a turbo compressor which is a back-to-back type, two-stage turbo compressor in which rear surfaces of two impellers face each other and are coupled with a preload applied.

A thrust bearing runner may be provided at a rear surface of the first impeller having a relatively large diameter. The thrust bearing runner and the first impeller may be coupled using the tie rod in a state in which the preload is applied, thereby obtaining a coupling force between the thrust bearing runner and the first impeller. A coupling shaft portion of each of the first impeller and the thrust bearing runner are inserted into an impeller sleeve or coupling sleeve provided between the first impeller and the thrust bearing runner to provide the coupling force between the first impeller and the thrust bearing runner by stationary fit between the impeller sleeve and the coupling shaft portion.

The rotary shaft may include a multistage structure in which diameters are reduced at an end of the rotary shaft coupled to the second impeller to increase a contact area between the second impeller and the rotary shaft on which the coupling force is applied. The turbo compressor may compress refrigerant supplied to the impeller by rotating the impeller based on an operation of a drive motor and cool an inside of the turbo compressor using the refrigerant discharged from the impeller.

The turbo compressor may include a cooling flow path branched from the discharge flow path to guide the refrigerant discharged from the impeller and connected to an inside of the bearing casing to accommodate the thrust bearing runner. In addition, the turbo compressor may include a recovery flow path to return the refrigerant supplied to the inside of the bearing casing to the impeller. A flow rate control valve may be provided in at least one of the cooling flow path or the recovery flow path to adjust a flow rate of the refrigerant supplied into the bearing casing.

In addition, the turbo compressor may include a heat exchanger on the cooling flow path to exchange heat between refrigerant in the cooling flow path and refrigerant suctioned through the suction flow path, thereby reducing a temperature of the refrigerant supplied through the cooling flow path.

According to embodiments disclosed herein, for a turbo compressor, a first impeller and a thrust bearing runner are coupled using a tie rod in a state in which a preload is applied, and a second impeller is coupled to a multistage rotary shaft by applying the preload to a small diameter portion of the rotary shaft. There is an advantage in that a coupling force between rotating components of the turbo compressor rotating at a high speed is obtained.

Further, there is an advantage in that rigidity of the rotary shaft may be easily obtained, and relatively higher operating frequency may be obtained. Furthermore, there is an advantage in that an insufficiency of the coupling force of the impeller may be resolved using a tie bolt.

In addition, there is an advantage in that the turbo compressor may efficiently cool a heat generating portion during an operation of the turbo compressor. The heat generated during operation of the turbo compressor may be cooled using fluid supplied to and compressed by the impeller, not using additional refrigerant, thereby simplifying a cooling structure of the turbo compressor.

Also, there is an advantage in that the turbo compressor directly supplies the fluid to the heat generating portion to effectively control a temperature of the heat generating portion. Moreover, there is an advantage in that the turbo compressor exchanges heat between the cooling fluid and the fluid introduced into the impeller to reduce a temperature of the cooling fluid and reduce a flow rate of the supplied fluid.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A turbo compressor, comprising:
a motor casing having a motor space;
a drive motor provided in the motor space;
a rotary shaft coupled to the drive motor and configured to transmit a rotational force;
an impeller coupled to a first side of the rotary shaft and configured to rotate together with a rotation of the rotary shaft;
a thrust bearing runner coupled to a second side of the rotary shaft opposite to the first side and configured to rotate together with the rotation of the rotary shaft;
a bearing casing to support the thrust bearing runner;
an inlet flow path configured to guide fluid introduced into the impeller;
a discharge flow path configured to guide fluid discharged from the impeller; and
a cooling flow path branched from the discharge flow path and configured to guide the fluid to the bearing casing.

2. The turbo compressor of claim 1, further comprising:
a recovery chamber configured to receive the fluid discharged from the bearing casing; and
a recovery flow path configured to guide the fluid received in the recovery chamber to the inlet flow path.

3. The turbo compressor of claim 1, further comprising a flow rate control valve provided in the cooling flow path and configured to control a flow rate of the fluid flowing through the cooling flow path.

4. The turbo compressor of claim 3, comprising:
a pressure sensor provided downstream of the flow rate control valve with respect to a flow direction of fluid passing through the flow rate control valve and configured to detect a pressure of the fluid passing through the flow rate control valve; and
a controller configured to receive the pressure detected by the pressure sensor and to control an opening degree of the flow rate control valve.

5. The turbo compressor of claim 1, further comprising a check valve provided in the cooling flow path and configured to prevent a backflow of the fluid flowing through the cooling flow path.

6. The turbo compressor of claim 1, further comprising a heat exchanger provided along the cooling flow path and in the inlet flow path, the heat exchanger being configured to perform heat-exchange between the fluid in the cooling flow path and fluid suctioned through the inlet flow path.

7. A turbo compressor, comprising:
a motor casing;
a drive motor provided in the motor casing;
a rotary shaft coupled to the drive motor and configured to transmit a rotational force;
an impeller coupled to a first side of the rotary shaft and configured to rotate with a rotation of the rotary shaft;
an impeller casing in which the impeller is provided and having a diffuser to convert gas flow accelerated by the impeller into pressure energy;
a thrust bearing runner coupled to a second side of the rotary shaft opposite to the first side, the thrust bearing runner being configured to rotate with the rotation of the rotary shaft;
a bearing casing that supports the thrust bearing runner;
an inlet flow path configured to guide fluid introduced into the impeller casing;
a discharge flow path configured to guide fluid discharged from the impeller casing;
a cooling flow path connected to the diffuser of the impeller casing and configured to guide the fluid of the diffuser to the bearing casing;
a recovery chamber configured to receive the fluid discharged from the bearing casing; and
a recovery flow path configured to guide the fluid received in the recovery chamber to the inlet flow path.

8. The turbo compressor of claim 7, further comprising a flow rate control valve provided in the cooling flow path and configured to control a flow rate of the fluid flowing through the cooling flow path.

9. The turbo compressor of claim 8, further comprising:
a pressure sensor provided in the cooling flow path and configured to detect a pressure of the fluid passing through the flow rate control valve; and
a controller configured to receive the pressure detected by the pressure sensor and to control an opening degree of the flow rate control valve.

10. The turbo compressor of claim 9, further comprising a check valve provided in the cooling flow path and configured to prevent a backflow of the fluid flowing through the cooling flow path.

11. A turbo compressor, comprising:
a motor casing having a motor space;
a drive motor provided in the motor space;
a rotary shaft coupled to the drive motor and configured to transmit a rotational force;
an impeller coupled to a first side of the rotary shaft and configured to rotate together with a rotation of the rotary shaft;
a thrust bearing runner coupled to a second side of the rotary shaft opposite to the first side and configured to rotate together with the rotation of the rotary shaft;
a bearing casing to support the thrust bearing runner;
an inlet flow path configured to guide fluid introduced into the impeller;
a discharge flow path configured to guide fluid discharged from the impeller;
a cooling flow path branched from the discharge flow path and configured to guide the fluid to the bearing casing; and
a flow rate control valve provided in the cooling flow path and configured to control a flow rate of the fluid flowing through the cooling flow path based on an adjusted opening degree of the flow rate control valve.

12. The turbo compressor of claim 11, comprising:
a pressure sensor provided downstream of the flow rate control valve with respect to a flow direction of fluid passing through the flow rate control valve and configured to detect a pressure of the fluid passing through the flow rate control valve; and
a controller configured to receive the pressure detected by the pressure sensor and to control the opening degree of the flow rate control valve.
